(19) United States
(12) Patent Application Publication
(10) Pub. No.: US 2006/0186731 A1
(43) Pub. Date: Aug. 24, 2006

(54) Method for stabilizing a motor vehicle whose speed is reduced to a standstill and brake system for carrying out said method

(75) Inventor: Thomas Bach, Wolken (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Lucas Automotive Gmbh

(21) Appl. No.: 11/412,278

(22) Filed: Apr. 27, 2006

Related U.S. Application Data
(63) Continuation of application No. PCT/EP04/12154, filed on Oct. 27, 2004.

(30) Foreign Application Priority Data
Oct. 31, 2003 (DE) 103 51 026.5

(51) Int. Cl. B60T 17/16

(52) U.S. Cl. 303/89; 303/191; 188/DIG. 2

(57) ABSTRACT

In a method of stabilising a vehicle which has been braked to a standstill, and is equipped with a braking system which can be actuated independently of the driver and includes a service brake and parking brake, it is provided that a parking brake force which is to be generated by the parking brake and maintains the vehicle standstill is determined after the vehicle standstill is reached, that a service brake force which is greater in amount than the previously determined parking brake force and simulates the parking brake is generated independently of the driver by means of the service brake, that the previously determined parking brake force is built up by means of the parking brake when or after the service brake force which simulates the parking brake is reached, and that the service brake is deactivated when or after the parking brake force is reached in the parking brake.

### CROSS-REFERENCE TO RELATED APPLICATIONS

This application is a continuation of International Application No. PCT/EP2004/012154 filed Oct. 27, 2004, the disclosures of which are incorporated herein by reference, and which claimed priority to German Patent Application No. 103 51 026.5 filed Oct. 31, 2003, the disclosures of which are incorporated herein by reference.

### BACKGROUND OF THE INVENTION

This invention concerns a method of stabilising a vehicle which has been braked to a standstill, and which is equipped with a braking system which can be actuated independently of the driver, the braking system including a service brake and a parking brake. The method also concerns a corresponding braking system.

From the prior art, equipping motor vehicle braking systems with a service brake and parking brake which can be actuated independently of the driver is already known. For instance, EP 0 825 081 B1, and corresponding U.S. Pat. No. 6,019,436 A1, both of which are incorporated by reference herein, describes such a braking system, in which the service brake is actuated hydraulically and the parking brake is actuated electromechanically. This means that in a service brake mode, for instance when the vehicle is braked during driving, the individual wheels of the vehicle are braked by these assigned braking devices, which can be actuated hydraulically. But if the vehicle is braked to a standstill and parked, i.e. if there is a change from service brake mode to parking brake mode, the parking brake is actuated electromechanically, in particular via a self-blocking mechanism, and kept in this parking brake mode until the parking brake mode is actively cancelled.

In the case of such a braking system, EP 0 825 081 B1 proposes that the transition from service brake mode into parking brake mode should take place only when the braking force applied by the parking brake has reached the braking force applied by the service brake. However, in this case there is the problem that in parking brake mode a different braking force distribution, i.e. a different distribution of individual braking force components, which determine the total braking force, to the wheels of the vehicle, is present from in service brake mode. In the case of many braking systems, in parking brake mode only the wheels of the rear axle are braked, whereas in service brake mode braking forces are present on all four wheels of the vehicle. The result can be that on transition from service brake mode to parking brake mode, unwanted rolling away or skidding away of the vehicle takes place, since the braking forces which act on the wheels which are braked in parking brake mode are insufficiently large to keep the vehicle at a standstill. Such a state occurs, for instance, if small coefficients of friction are present in particular on the wheels which are braked in parking brake mode, because of iced places on the roadway. An example of another case which can result in the situation described above of undesired rolling away occurs in the case of a heavily loaded vehicle standing on an inclined roadway.

### BRIEF SUMMARY OF THE INVENTION

In contrast, it is an object of this invention to provide a method of stabilising a vehicle which has been braked to a standstill, and a corresponding braking system, which on transition from service brake mode to parking brake mode hold the vehicle reliably at a standstill.

This object is achieved by a method of stabilising a vehicle which has been braked to a standstill, and is equipped with a braking system which can be actuated independently of the driver and includes a service brake and parking brake, a parking brake force which is to be generated by the parking brake and maintains the vehicle standstill being determined after the vehicle standstill is reached, a service brake force which is greater in amount than the previously determined parking brake force and simulates the parking brake being generated independently of the driver by means of the service brake, the previously determined parking brake force being built up by means of the parking brake when or after the service brake force which simulates the parking brake is reached, and the service brake being deactivated when or after the parking brake force is reached in the parking brake.

This object is also achieved by a braking system which works correspondingly.

In the case of the invention, therefore, the braking force which is built up in the service brake to brake the vehicle is not used to determine the parking brake force. Instead, according to the invention the amount of a parking brake force which keeps the vehicle at a standstill is determined. After the amount of this parking brake force is determined, the service brake force which simulates the parking brake is built up in the service brake. This can require that the amount of the braking force which is built up by means of the service brake to bring the vehicle to a standstill, i.e. to brake the vehicle completely, is increased, maintained or reduced, depending on the magnitude of the previously determined parking brake force. As soon as the service brake force which simulates the parking brake is built up, the parking brake can actually be actuated, by being put into a state in which the previously determined parking brake force is set up. Then, after complete actuation of the parking brake, the service brake can be deactivated. The vehicle is then in a state which is secured by the parking brake, and the parking brake secures the vehicle reliably against unintentional rolling away or skidding away.

In an extension of the invention, it is provided that after the vehicle comes to a standstill, the braking force which is built up in the service brake is first maintained, independently of the driver, and after the expiry of a predetermined first time interval, is set to the amount of the service brake force which simulates the parking brake. In other words, after complete braking of the vehicle and in the absence of further actions by the driver from which continued driving can be deduced, first the braking force which is built up in the service brake when the vehicle is braked is maintained over the first time interval by means of the service brake. This time interval can be, for instance, a few minutes. If no change because of an action by the driver occurs during this time interval, according to the invention the transition to actuating the service brake is automatically initiated. This is advantageous in particular because in general, the braking forces which are required to stabilise permanently the vehicle which has been braked to a standstill cannot be applied, or can be applied only with very high energy cost, using the service brake. The reason for this is that the service brake is usually in the form of a hydraulically actuated brake, and because of leakages and mechanical losses, requires regular and therefore energy-intensive conveyance of hydraulic fluid to maintain the braking force. By handing over the braking effect to a parking brake which works electromechanically, with a mechanism which self-inhibits as required, the service brake can be deactivated.

However, by setting the first time interval sufficiently long, it is possible to prevent the parking brake being actuated early, which could undesirably delay continued driving which the driver intends.

In this connection, an extension of the invention provides that when the driver actively actuates the service brake within the first time interval, the course of the first time interval is restarted. Active actuation of the service brake within the first time interval leads to the conclusion that the driver may have detected that the braking force built up in the service brake system to brake the vehicle was insufficient to keep the vehicle at a standstill. The driver therefore actuates the service brake again, and raises the braking force built up in it to a higher amount. This action then ensures that the individual steps of the method according to the invention are restarted, and in particular the course of the first time interval is restarted.

An extension of the invention provides that the service brake force which simulates the parking brake is maintained in the service brake over a predetermined second time interval. Introducing the second time interval ensures that components of a vehicle sensor system can detect whether the service brake force which simulates the parking brake is sufficiently large to stabilise the vehicle at a standstill. This second time interval also ensures a sufficiently large period for building up the parking brake force in the parking brake, with relatively low energy cost. Since individual brake components such as brake pistons and floating caliper arrangements have already been put into the braking state by the service brake, the parking brake, which also uses these components to achieve the braking force, can be converted into a position which ensures the parking brake force without great counter-forces.

Also, in an implementation variant of the invention, it is provided that when the driver actively actuates the service brake before the second or third time interval expires, the parking brake is deactivated. This means that the transition to parking brake mode, i.e. actuation of the parking brake, does not occur or is aborted when the driver actively intervenes within the second or third time interval.

Regarding the determination of the parking brake force, according to the invention it can be provided that the amount or/and a braking force distribution of the parking brake force to individual vehicle wheels can be determined from operating parameters of the vehicle. In this context, an implementation variant of the invention provides that the operating parameters include information about the current vehicle tilt or/and the current load state or/and the current brake temperature or/and the prevailing friction conditions between vehicle wheels and road surface. To determine these operating parameters, for instance a tilt sensor, sensors of the vehicle shock absorption, temperature sensors, slip detection sensors or r.p.m. sensors can be used.

With reference to the service brake force which simulates the parking brake, according to the invention it can be provided that this exceeds the previously determined parking brake force by at least 5%, relative to the amount of the previously determined parking brake force. However, in the case of an alternative design of the braking system, greater differences by amount between parking brake force and service brake force can be chosen, for instance at least 10%, at least 15% or at least 20%.

A technically specially simple implementation of the invention results if, for instance, control of the service brake and parking brake is integrated in a stability system of the vehicle. In this case, components which are already present in the stability system, such as processors or data memories, can be used.

As indicated above, various actions by the driver during the execution of individual steps of the method according to the invention can result in abortion of the method. Another such case exists, for instance, if the driver actively starts driving. In this case, the invention provides that the service brake or/and the parking brake are automatically released.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a schematic representation of the wheels of a motor vehicle;

FIG. 2 shows a time-force diagram for a first sequence of the method according to the invention, and

FIG. 3 shows a time-force diagram for a second sequence of the method according to the invention.

### DETAILED DESCRIPTION OF THE INVENTION

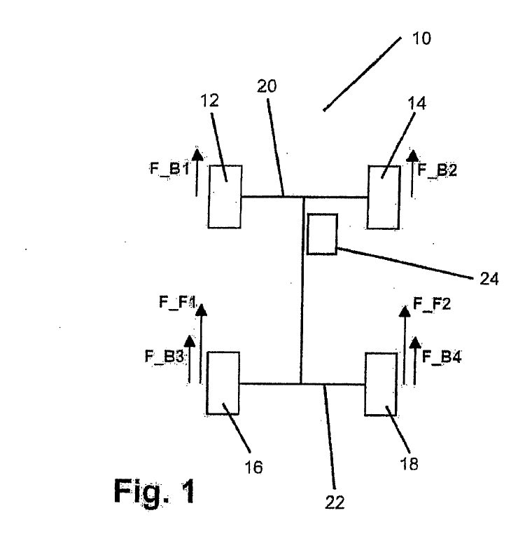

FIG. 1 shows a schematically represented motor vehicle which is generally designated with 10. This has four wheels, i.e. the two front wheels 12 and 14 and the two rear wheels 16 and 18.

The two front wheels 12 and 14 are linked via a front axle 20, whereas the two rear wheels 16 and 18 are linked via a rear axle 22. A service brake which can be actuated hydraulically, and the control of which is generally designated with 24, acts on all four wheels 12, 14, 16 and 18. In service brake mode, i.e. if the service brake is activated in normal driving operation of the vehicle 10, the braking force F_B1 acts on the front wheel 12, the braking force F_B2 acts on the front wheel 14, the braking force F_B3 acts on the rear wheel 16, and the braking force F_B4 acts on the front wheel 18. In contrast, in parking brake mode, for instance when the vehicle has been parked, in the case of the example holding forces act only on the two rear wheels 16 and 18, that is the holding force F_F1 acts on the rear wheel 16 and the holding force F_F2 acts on the rear wheel 18. These holding forces are applied by the parking brake, which can be actuated electromechanically.

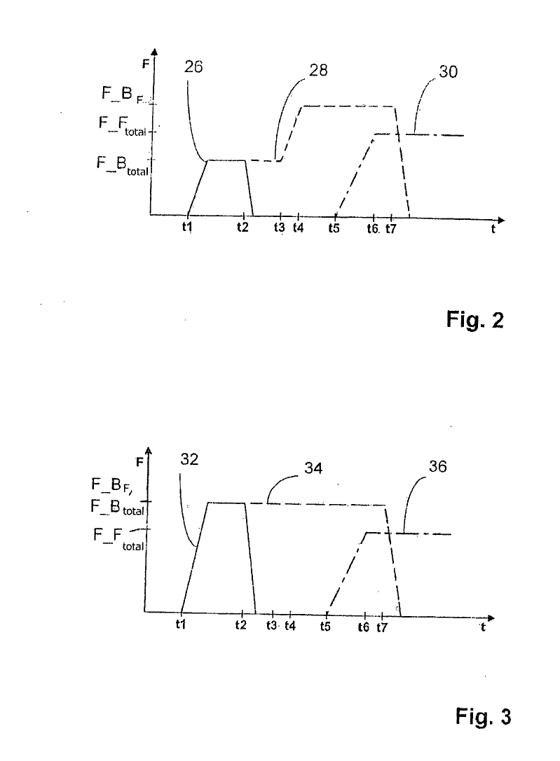

Below, how the service brake and parking brake work together according to a first variant of the method according to the invention is described with reference to FIG. 2.

At time t1, the driver of the moving vehicle 10 actuates the service brake by pressing a brake pedal. In this way, the braking force F_Bₜₒₜₐₗ is built up in the service brake according to the curve 26, which is drawn with a continuous line. It consists of:

F_Bₜₒₜₐₗ=F_B1+F_B2+F_B3+F_B4

Between times t1 and t2, the vehicle is braked to a standstill by the braking effect of the service brake. At time t2, the driver releases the brake pedal. However, according to the dashed curve 28, the braking force F_Bₜₒₜₐₗ is maintained in the service brake until time t3. In this time interval, i.e. between times t2 and t3, a parking brake force F_Fₜₒₜₐₗ is determined. This parking brake force F_Fₜₒₜₐₗ is determined from various vehicle parameters and operating parameters, e.g. the current vehicle tilt, the current load state, the current brake temperature, the friction conditions between each vehicle wheel and the road surface. The parking brake force F_Fₜₒₜₐₗ is set at a value which ensures reliable stabilisation of the vehicle in the braked to a standstill state, taking account of these parameters.

At time t3, the amount of the parking brake force F_Fₜₒₜₐₗ is determined. If, in the period between t2 and t3, there has been no active effect on the braking system or vehicle state by the driver, from time t3 to time t4, corresponding to the course of the dashed curve 28, the service brake of the vehicle 10 is controlled, with no active effect by the driver, in such a way that the braking forces which are applied by the service brake in total reach the service brake force F_B_{F}, which simulates the parking brake. The amount of this service brake force F_B_{F}, which simulates the parking brake, is greater than the previously specified parking brake force F_Fₜₒₜₐₗ. Accordingly:

F_B_{F}>F_Fₜₒₜₐₗ

If no active effect by the driver takes place, the service brake force F_B_{F} is reached at time t4 and maintained unchanged until time t7. Within this time interval t4 to t7, after expiry of a specified time span, i.e. at time t5, the parking brake is activated according to the dash-dot curve 30. In other words, at time t5 the parking brake is activated, and an electromechanical positioning mechanism which is associated with it is controlled until it reaches a position which corresponds to the previously specified parking brake force F_Fₜₒₜₐₗ. Because, at time t6, the brake position which corresponds to the parking brake force F_Fₜₒₜₐₗ was reached, the parking brake is not positioned further, i.e. its state is maintained unchanged from time t6.

At time t7, a short time after time t6 is reached, the service brake is deactivated, i.e. the hydraulic pressure which prevails in the service brake is reduced to its initial level. This means that the vehicle is now only held in the unmoved state by the parking brake, which ensures a parking brake force of the amount F_Fₜₒₜₐₗ.

The timing of the steps described above can be controlled as desired. For instance, the time interval between t2 and t3 can last one or more minutes. The time intervals can also be chosen depending on the situation.

It should be pointed out that the parking brake force F_Fₜₒₜₐₗ is made up of individual components F_F1 and F_F2, as shown in FIG. 1, i.e. of different braking forces which are applied to the rear wheels, so that in the case of the example:

F_Fₜₒₜₐₗ=F_F1+F_F2

However, within the invention it is equally possible to achieve the parking brake force F_Fₜₒₜₐₗ by a different kind of braking force distribution, e.g. by distribution to three or all four vehicle wheels, two vehicle wheels on the same side of the vehicle or diagonally arranged vehicle wheels. Similarly, the braking forces F_Bₜₒₜₐₗ and F_B_{F} which are applied by the service brake are made up of different components which are present in the individual vehicle wheels. The service brake force F_Bₜₒₜₐₗ which is built up to brake the vehicle can be made up of force components which are present at all four vehicle wheels 12 to 18, whereas the service brake force F_B_{F} which simulates the parking brake, analogously to the parking brake force F_Fₜₒₜₐₗ, can be made up of force components which are present at only two vehicle wheels.

The method sequence of a second variant according to the invention, shown in FIG. 3, differs from the method sequence according to FIG. 2 only in that the driver, according to the curve 32, to brake the vehicle 10, presses the brake pedal at time t1 significantly more intensively, and thus builds up a significantly greater braking force F_Bₜₒₜₐₗ in the service brake. At time t2, the driver releases the brake pedal, at which time, as described above with reference to FIG. 2, the braking force F_Bₜₒₜₐₗ is maintained according to the dashed curve 34. Between times t2 and t3, the parking brake force F_Fₜₒₜₐₗ is determined, and the braking system establishes that the instantaneously built up service brake force F_Bₜₒₜₐₗ is already greater than the determined parking brake force F_Fₜₒₜₐₗ. Accordingly, the amount of the instantaneously prevailing service brake force F_B_{F} is maintained until time t7 and—as described above with reference to FIG. 2—building up the parking brake force F_Fₜₒₜₐₗ according to the dash-dot curve 36 begins at time t5. If this is completed at time t6, a little later, at time t7, the service brake force F_B_{F} which simulates the parking brake is reduced in the service brake by deactivating the service brake.

The invention shows one possibility, in the case of a traditional braking system, by targeted control of the service brake and parking brake, for ensuring a reliable transition into parking brake mode without incurring the risk that the braking forces which are present in parking brake mode do not give sufficient hold.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Method of stabilizing a vehicle which has been braked to a standstill, and is equipped with a braking system which can be actuated independently of the driver and includes a service brake and parking brake, the method comprising the steps of:
(a) determining a parking brake force which is to be generated by the parking brake that is sufficient to maintain the vehicle at a standstill after the vehicle standstill is reached;
(b) generating a service brake force which is greater in amount than the previously determined parking brake force, and which simulates the parking brake, the force components of which being distributed to the vehicle wheels analogously to the force components of the parking brake force, the service brake force being generated independently of the driver by means of the service brake;
(c) building up the previously determined parking brake force by means of the parking brake, when or after the service brake force which simulates the parking brake is reached; and
(d) deactivating the service brake when or after the parking brake force is reached in the parking brake.

2. Method according to claim 1, wherein after the vehicle comes to a standstill, the braking force which is built up in the service brake is first held independently of the driver, and after the expiry of a predetermined first time interval is set to the service brake force which simulates the parking brake.

3. Method according to claim 2, wherein if the driver actively actuates the service brake within the first time interval, the course of the first time interval is restarted.

4. Method according to claim 2, wherein the service brake force which simulates the parking brake is maintained in the service brake over a predetermined second time interval.

5. Method according to claim 4, wherein after the service brake force which simulates the parking brake is reached, the parking brake is activated after the expiry of a predetermined third time interval.

6. Method according to claim 5, wherein if the driver actively actuates the service brake before the expiry of one of the second and third time intervals, the parking brake is deactivated.

7. Method according to claim 1, wherein the amount distribution of the parking brake force to individual vehicle wheels is determined from operating parameters of the vehicle.

8. Method according to claim 7, wherein the operating parameters include information about at least one of the current vehicle tilt; the current vehicle load state; the current brake temperature; and the prevailing friction conditions between vehicle wheels and road surface.

9. Method according to claim 1, wherein the service brake force which simulates the parking brake exceeds the previously determined parking brake force by at least 5%, relative to the amount of the previously determined parking brake force.

10. Method according to claim 1, wherein control of the service brake and parking brake is integrated in a stability system of the vehicle.

11. Method according to claim 1, wherein the service brake is actuated hydraulically.

12. Method according to claim 1, wherein the parking brake is actuated electromechanically.

13. Method according to claim 1, wherein at least one of the service brake and the parking brake is automatically released if the driver actively starts driving the vehicle.

14. Braking system to stabilize a vehicle which has been braked to a standstill, the braking system comprising:
a service brake that can be actuated independently of a driver;
a parking brake that can be actuated independently of a driver; and
a brake controller that is operable to determine a parking brake force which is to be generated by the parking brake that is sufficient to maintain the vehicle at a standstill after the vehicle standstill is reached, the brake controller also being operable to cause the service brake to generate, independently of the driver, a service brake force, which is greater in amount than the previously determined parking brake force, and which simulates the parking brake, the force components of which being distributed to the vehicle wheels analogously to the force components of the parking brake force, the brake controller being further operable to build up, when or after the service brake force which simulates the parking brake is reached, by means of the parking brake, the previously determined parking brake force, and, when or after the parking brake force is reached in the parking brake, to deactivate the service brake.
